(19) United States
(12) Patent Application Publication
(10) Pub. No.: US 2022/0004717 A1
(43) Pub. Date: Jan. 6, 2022

(54) METHOD AND SYSTEM FOR ENHANCING DOCUMENT RELIABILITY TO ENABLE GIVEN DOCUMENT TO RECEIVE HIGHER RELIABILITY FROM READER

(71) Applicant: Korea Advanced Institute of Science and Technology, Daejeon (KR)

(72) Inventors: Jong Cheol Park, Daejeon (KR); Wonsuk Yang, Daejeon (KR); Jung-Ho Kim, Daejeon (KR)

(73) Assignee: Korea Advanced Institute of Science and Technology, Daejeon (KR)

(21) Appl. No.: 17/297,627

(22) PCT Filed: Sep. 30, 2019
(86) PCT No.: PCT/KR2019/012737

§ 371 Date: Jul. 12, 2021

(30) Foreign Application Priority Data
Nov. 30, 2018 (KR) 10-2018-0151722

(51) Int. Cl. G06F 40/30; G06F 40/216; G06F 40/279; G06F 16/33

(52) U.S. Cl. CPC G06F 40/30; G06F 16/3335; G06F 40/279; G06F 40/216

(57) ABSTRACT

Disclosed is a method and system for enhancing document reliability to enable a given document to receive higher reliability from a reader. A method for enhancing document reliability according to an embodiment of the present invention comprises the steps of: when a document is input by a user, generating a correction candidate set for each sentence of the input document; predicting a reliability distribution for each of the generated correction candidate set and the input document; and enhancing reliability of the input document via a plurality of enhancement schemes based on a standard deviation and a mean of the predicted reliability distribution.

### TECHNICAL FIELD

Example embodiments of the following description relate to technology for enhancing reliability of a document and more particularly, to a method and system that may perform an automatic reliability distribution prediction on an available correction candidate set for a given document and may perform reliability enhancement based on a change in a standard deviation and a mean appearing in a reliability distribution for a correction candidate set and an original document.

### RELATED ART

With advancement in natural language processing technology and improvement in performance of automatic analysis technology for semantic/pragmatic features, development of research technology and commercialization for an automatic document correction system are actively ongoing.

As an example of technology for the automatic document correction system, the corresponding technology has researched and developed the automatic document correction system based on a learning model using a neural machine translation (NMT) and has experimentally proved that the corresponding system has high performance of F0.5 score corresponding to about 40% with respect to CoNLL-2014 Shared task test set for automatic grammar correction. As another example for the automatic document correction system, the corresponding technology has searched for an evaluation index that may best match linguistic judgment of a native language user in evaluating an automatic grammar correction system and proposed a GLEU indicator that is a modification of an existing bilingual evaluation understudy (BLEU) indicator having been used to evaluate an automatic grammar correction method and system. As another example of technology for the automatic document correction system, the corresponding technology has researched and developed ERRANT that is an annotation aid tool for effectively building learning data and evaluation data required to build the automatic document correction system. As another example of technology for the automatic document correction system, the corresponding technology has built a large-scale learning evaluation data corpus for training and evaluating an automatic in-depth correction system for technical documents. As another example of technology for the automatic document correction system, the corresponding technology has researched and developed an automatic grammar correction system having high performance for various topics of documents using a neural sequence-to-sequence model that is trained based on EF-Cambridge Open Language Database (EFCAMDAT), a large-scale evaluation data corpus for automatic grammar correction.

As a representative commercialization example for the automatic document correction system, Grammarly provides an automatic grammar correction and tone correction service for a document input from a user. In this regard, U.S. Pat. No. 9,465,793B2 (granted, 2016 Oct. 11), “Systems and methods for advanced grammar checking,” has proposed an automated grammar error correction, a correction suggestion, and a method of prioritizing grammar error correction suggestion candidates. Also, Grammarly has added an automatic correction suggestion function for a sentence style based on the intent of a document (e.g., providing of new information, description of a specific topic, persuasion, and storytelling), characteristics of a reader (e.g., general, intellectual, and expert), a style of a document (e.g., formal and informal), emotional intensity of a document (e.g., weak and strong), a document domain (e.g., general, academic, business, technical, creative, and causal) as well as simple grammar correction and tone correction.

As another representative commercialization example, G-Suite of Google has recently added an automated grammar error correction suggestion function to a service, such as, for example, Google Docs and Gmail. Another representative commercialization example has researched and developed a program configured to automatically provide feedback on persuasive power, topic development, consistency, grammar errors, and word selection of a document as an additional function program for the Google Docs service.

The existing methodology for automatic document correction is limited to concepts with relatively high public consensus and is difficult to apply to a value with a large individual difference, such as the concept of a reliability.

For example, in the existing methodology for automatic document correction, persuasive power and consistency of a document analyzed as related factors relate to characteristics of sentence arrangement and components in the document and thus, have high public consensus and emotional intensity also has high public consensus.

Reliability for a given sentence is defined in relation to whether a specific event has actually occurred (factuality) or defined in relation to whether specific assertion/content of a specific speaker is trusted. Reliability studies conducted on whether a specific event has actually occurred (factuality) have confirmed that public consensus is relatively high on this.

However, since a reliability concept related to the specific assertion/content spoken by the specific speaker is very closely related to individual subjectivity, it has been confirmed through a plurality of studies that a consensus is low on which sentence/document is trusted.

Differently describing, the public consensus in relation to that a specific document has high/low persuasive power, has high/low consistency, and has high/low emotional intensity is higher than the public consensus in relation to that a specific document contains reliable/unreliable content due to the following reasons. The persuasive power/consistency relates to a structure of thesis. In the case of a document with a clear thesis structure, the corresponding document may be evaluated to have high persuasive power/consistency although there is an antipathy against the contents. Also, since emotional intensity also has limited emotion-provoking words and emotion-provoking expressions, the consensus is high on evaluation that a document using many corresponding words and expressions has high emotional intensity.

However, since the reliability relates to an individual subjective belief, what kind of belief a corresponding reader has about the contents is a most important factor to determine the reliability, which may be greatly affected by demographic characteristics and may be affected by individual subjectivity that may not be defined as demographic characteristics. Therefore, the public consensus on reliability evaluation is relatively low.

Accordingly, if the existing methodology for automatic document correction simply evaluates appropriateness of a document correction candidate set or correction suggestion through an indicator defined as a single number, such as, for example, a score of consistency, a score of persuasive power, and a score of emotional intensity, there is a need to evaluate the appropriateness of a document correction candidate set or correction suggestion based on a reliability distribution concept that considers an individual difference for document correction and correction to enhance reliability.

### DETAILED DESCRIPTION

### Subject

Example embodiments provide a method and system that may perform an automatic reliability distribution prediction on an available correction candidate set for a given document and may perform reliability enhancement based on a change in a standard deviation and a mean appearing in a reliability distribution for a correction candidate set and an original document.

### Solution

A method of enhancing document reliability according to an example embodiment includes, when a document is input from a user, generating a correction candidate set for each sentence of the input document; predicting a reliability distribution for each of the input document and the generated correction candidate set; and performing reliability enhancement for the input document through a plurality of enhancement schemes based on a mean and a standard deviation of the predicted reliability distribution.

Also, the document reliability enhancement method may further include providing the user with a reliability-enhanced document with enhanced reliability for the input document and information about a change in the reliability distribution occurring before and after the reliability enhancement.

The providing the user may include further providing the user with document correction results most similar to a mode of a reliability distribution desired by the user through interaction with the user.

The plurality of enhancement schemes may include at least one item among a first item corresponding to reliability enhancement of a scheme that aims at a preset reference mean or more of the reliability distribution, a second item corresponding to reliability enhancement of a scheme that aims at a standard deviation less than a preset reference standard deviation of the reliability distribution, and a third item corresponding to reliability enhancement of a scheme that aims at {mean/standard deviation} greater than or equal to a preset standard {mean/standard deviation} of the reliability distribution.

The generating may include receiving control information about the plurality of enhancement schemes from the user; performing preprocessing of each sentence of the input document; and generating a plurality of correction candidate sentence sets for each sentence of the input document, the predicting may include predicting a reliability distribution for each sentence of a plurality of document sets combinable through the respective sentences of the input document and the respective sentences in the correction candidate sentence sets, and the performing may include performing the reliability enhancement for the input document by selecting a reliability-enhanced document based on the predicted reliability distribution for each sentence of the plurality of document sets and the control information.

A document reliability enhancement system according to an example embodiment includes a generator configured to, when a document is input from a user, generate a correction candidate set for each sentence of the input document; a predictor configured to predict a reliability distribution for each of the input document and the generated correction candidate set; and an enhancer configured to perform reliability enhancement for the input document through a plurality of enhancement schemes based on a mean and a standard deviation of the predicted reliability distribution.

Also, the document reliability enhancement system may further include an outputter configured to provide the user with a reliability-enhanced document with enhanced reliability for the input document and information about a change in the reliability distribution occurring before and after the reliability enhancement.

The outputter may be configured to further provide the user with document correction results most similar to a mode of a reliability distribution desired by the user through interaction with the user.

The plurality of enhancement schemes may include at least one item among a first item corresponding to reliability enhancement that aims at a preset reference mean or more of the reliability distribution, a second item corresponding to reliability enhancement of a scheme that aims at a standard deviation less than a preset reference standard deviation of the reliability distribution, and a third item corresponding to reliability enhancement of a scheme that aims at {mean/standard deviation} greater than or equal to a preset standard {mean/standard deviation} of the reliability distribution.

The generator may be configured to receive control information about the plurality of enhancement schemes from the user, to perform preprocessing of each sentence of the input document, and to generate a plurality of correction candidate sentence sets for each sentence of the input document, the predictor may be configured to predict a reliability distribution for each sentence of a plurality of document sets combinable through the respective sentences of the input document and the respective sentences in the correction candidate sentence sets, and the enhancer may be configured to perform the reliability enhancement for the input document by selecting a reliability-enhanced document based on the predicted reliability distribution for each sentence of the plurality of document sets and the control information.

### Effect

According to example embodiments, it is possible to perform an automatic reliability distribution prediction on an available correction candidate set for a given document and to perform reliability enhancement based on a change in a standard deviation and a mean appearing in a reliability distribution for a correction candidate set and an original document.

According to example embodiments, since a necessary condition, the introduction of a distribution concept, is met, a document correction for a reliability concept including a large individual difference is enabled. That is, the example embodiments may (1) perform reliability enhancement of a scheme that aims at a high mean of a reliability distribution and correct a document such that more people may trust the document subject to the reliability enhancement, (2) perform reliability enhancement of a scheme that aims at a low standard deviation of the reliability distribution and correct the document such that there is no room for controversy about an issue whether to trust the document subject to the reliability enhancement, and (3) perform reliability enhancement of a scheme that aims at high {mean/standard deviation} of the reliability distribution and correct the document subject to reliability enhancement in a combined manner of the two schemes.

According to example embodiments, with respect to each sentence of a document to be corrected, a user may input a mode of a desired reliability distribution through a drag-and-drop scheme and a sentence correction candidate showing a most similar reliability distribution mode to the mode of the corresponding reliability distribution may be provided to the user. Therefore, according to the example embodiments, document correction for reliability enhancement, which is difficult to apply to an automated correction system since it is greatly affected by individual subjectivity, is enabled through introduction of a distribution concept. Through this, detailed information about how the document needs to be transformed to earn more trust from a group of unspecific others may be provided in various forms.

The present example embodiments may perform an automatic correction for an official document, news, and a technical document in which reliability of a reader is important and may produce a document with high reliability based on individual subjectivity.

### BRIEF DESCRIPTION OF DRAWINGS

FIG. 1 illustrates a configuration of a document reliability enhancement system according to an example embodiment.

FIG. 2 is a diagram illustrating an example of a configuration of a reliability enhancer of FIG. 1.

FIG. 3 is a diagram illustrating an example of a configuration of an outputter of FIG. 1.

FIG. 4 illustrates an example for describing output results of a document reliability enhancement system according to an example embodiment.

FIG. 5 illustrates an example of a document correction candidate corpus included in the document reliability enhancement system.

FIG. 6 illustrates an example of a reliability distribution corpus included in the document reliability enhancement system.

FIG. 7 is a flowchart illustrating an example by the reliability enhancer of FIG. 1.

FIG. 8 is a flowchart illustrating an example by the outputter of FIG. 1.

### BEST MODE

Aspects and features of the disclosure and methods to achieve the same may become clear with reference to the accompanying drawings and the following example embodiments. Example embodiments, however, may be embodied in various different forms, and should not be construed as being limited to only the illustrated embodiments. Rather, the illustrated embodiments are provided as examples so that this disclosure will be thorough and complete, and are defined by the scope of the claims.

The terms used herein are to describe the example embodiments and not to limit the disclosure. As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, and elements.

Unless otherwise defined, all terms (including technical and scientific terms) used herein have the same meaning as commonly understood by one of ordinary skills in the art to which the example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Hereinafter, the example embodiments will be described in more detail with reference to the accompanying drawings. Like reference numerals refer to like elements throughout and further description related thereto is omitted.

The example embodiments are to perform an automatic reliability distribution prediction on an available correction candidate set for a given document and to perform reliability enhancement based on a change in a standard deviation and a mean appearing in a reliability distribution for a correction candidate set and an original document.

Here, the example embodiments may perform reliability enhancement using a plurality of enhancement schemes based on a mean and a standard deviation of a reliability distribution including at least one of a first item corresponding to reliability enhancement of a scheme that aims at a high mean of the reliability distribution, a second item corresponding to reliability enhancement of a scheme that aims at a low standard deviation of the reliability distribution, and a third item corresponding to reliability enhancement of a scheme that aims at high {mean/standard deviation} of the reliability distribution.

Further, the example embodiments may perform reliability enhancement for a document input from a user and then provide the user with a statistical index related to an enhanced document in a graph form and may perform preliminary monitoring regarding what kind of reliability change may be observed from a group of unspecific others according to fine adjustment of the document input from the user through interaction with the user.

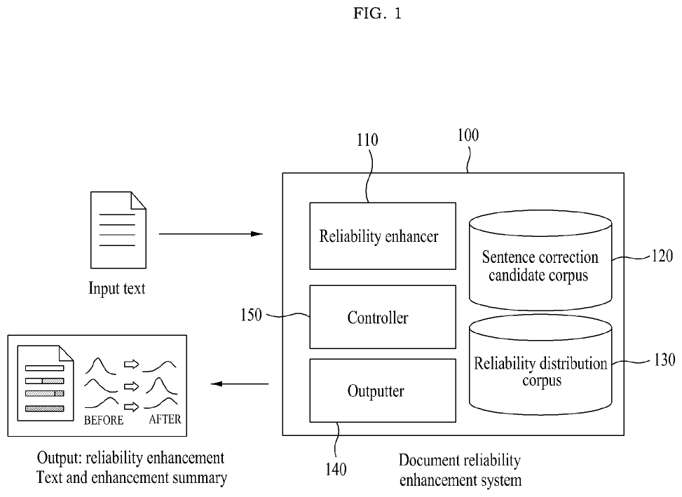

FIG. 1 illustrates a configuration of a document reliability enhancement system according to an example embodiment.

Referring to FIG. 1, a document reliability enhancement system 100 according to an example embodiment includes a reliability enhancer 110, a sentence correction candidate corpus 120, a reliability distribution corpus 130, an outputter 140, and a controller 150.

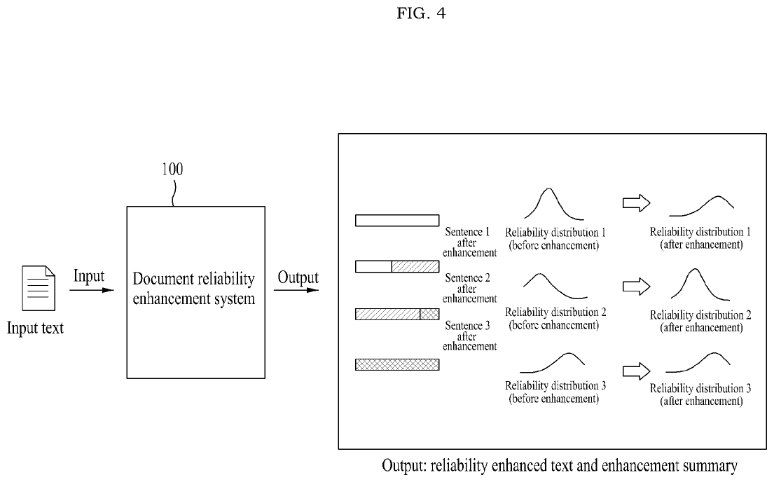

Here, referring to FIG. 4, the document reliability enhancement system 100 may perform reliability enhancement for each sentence of a document (input text) input from a user and may provide the user with a reliability-enhanced document and at the same time, may provide the user with a reader reliability distribution corresponding to before/after the reliability enhancement for each sentence.

The reliability enhancer 110 performs reliability enhancement for the input document through a plurality of enhancement schemes based on a mean and a standard deviation of the reliability distribution.

Here, the plurality of enhancement schemes based on the mean and the standard deviation of the reliability distribution may include at least one of a first item corresponding to reliability enhancement of a scheme that aims at a high mean, for example, a preset reference mean or more of the reliability distribution, a second item corresponding to reliability enhancement of a scheme that aims at a low standard deviation, for example, a standard deviation less than a preset reference standard deviation of the reliability distribution, and a third item corresponding to reliability enhancement of a scheme that aims at high {mean/standard deviation}, for example, {mean/standard deviation} greater than or equal to a preset standard {mean/standard deviation} of the reliability distribution.

In detail, the reliability enhancement of the scheme that aims at the high reliability mean may be understood to correct the document such that more people may trust the document subject to the reliability enhancement, the reliability enhancement of the scheme that aims at the low reliability standard deviation may be understood to correct the document such that there is no controversial issue regarding whether to trust the document subject to the reliability enhancement, and the reliability enhancement of the scheme that aims at the high {mean/standard deviation} value may be understood as a combination of the two schemes.

That is, the reliability enhancer 110 may receive the document subject to reliability enhancement from the user, may selectively receive, from the user, information (hereinafter, referred to as control information) about a scheme of information to be output and provided among the plurality of enhancement schemes based on the mean and the standard deviation of the reliability distribution, may transmit the control information to the controller 150, may generate a correction candidate set for each sentence in the given document, may receive the control information again from the controller 150, and may select a document matching the control information from among documents respectively corresponding to the plurality of enhancement schemes based on the mean and the standard deviation of the reliability distribution from among documents generatable by combining the correction candidate sets.

Here, the documents respectively corresponding to the plurality of enhancement schemes based on the mean and the standard deviation of the reliability distribution may include (1) an after-correction document with a highest mean of a reliability distribution predicted over the entire document, (2) an after-correction document with a lowest standard deviation of the reliability distribution predicted over the entire document, and (3) an after-correction document with a highest {mean/standard deviation} value of predicted reliability distribution over the entire document.

Further, unless the control information is input from the user, the reliability enhancer 110 may output and provide, as the control information, information corresponding to all of the plurality of enhancement schemes based on the mean and the standard deviation of the reliability distribution.

The sentence correction candidate corpus 120 stores a sentence (hereinafter, referred to as an “after-correction sentence”) applied with a correction of a scheme that transforms a sentence structure while maintaining the meaning of the sentence in a passive manner by a language expert, an original sentence, and a semantic difference between the original sentence and the after-correction sentence that is determined by the language expert as a point within the range of zero points (i.e., indicating no semantic difference) to 5 points (i.e., indicating a significant semantic difference).

Here, the sentence correction candidate corpus 120 may use, as a learning reference for supervised learning of a corresponding model when the reliability enhancer 110 uses a model configured to generate a correction candidate set for each sentence in the given document.

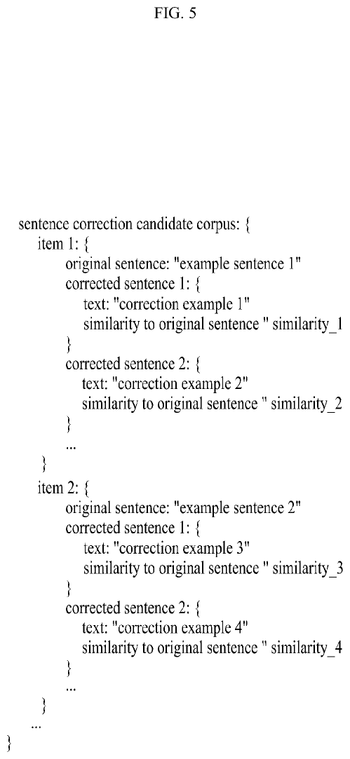

FIG. 5 illustrates an example of a sentence correction candidate corpus included in a document reliability enhancement system. Referring to FIG. 5, the sentence correction candidate corpus stores a plurality of example sentence sets and a plurality of corrected sentences for each example sentence and also stores a similarity to an original sentence before correction for each corrected sentence.

The reliability distribution corpus 130 stores a reliability distribution of readers on each sentence collected through a direct reliability survey.

Here, the reliability distribution corpus 130 may use, as a learning reference for supervised learning of a corresponding model when the reliability enhancer 110 includes a reliability distribution prediction model to predict a reliability distribution of an after-correction document.

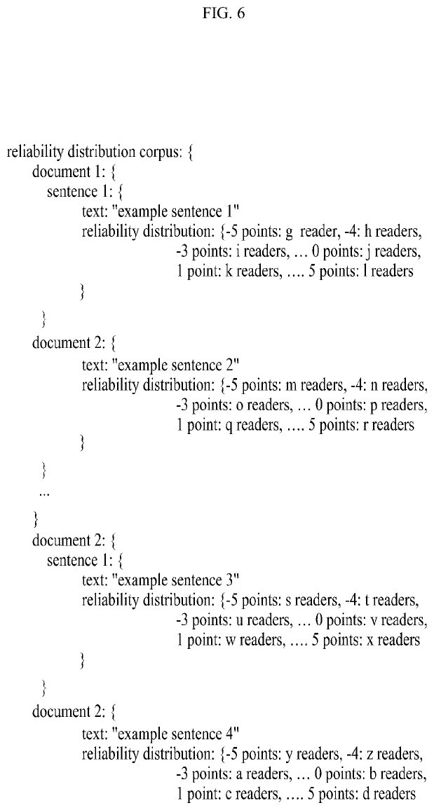

FIG. 6 illustrates an example of a reliability distribution corpus included in a document reliability enhancement system. Referring to FIG. 6, the reliability distribution corpus stores a plurality of document sets and a reliability distribution of each of reader groups for each sentence through an actual survey.

Further, the plurality of document sets stored by the reliability distribution corpus 130 may need to include various types of documents on various topics that may be encountered in daily life. As an example of detailed description, topics of documents may include life, health, politics, policy, economy, and environment, and types of documents may include a social network service (SNS) post, a blog post, online news, an online forum post, research paper, and a book. Desirably, a topic and a type of each of documents subject to a direct survey over the entire corpus need to be different since the reliability distribution corpus 130 collected through a survey through a system according to an example embodiment is used as a learning reference for automatically predicting a reliability distribution. If the reliability distribution corpus 130 includes documents related to life/health and only reliability survey results of readers on the documents, a prediction model trained through a corresponding prediction reference corpus may be inappropriate to predict a reliability distribution of a document on politics/policy and corresponding prediction results may be estimated to differ from an actual reliability distribution of the readers.

The outputter 140 outputs and provides a reliability-enhanced document selected by the reliability enhancer 110 to the user. At the same time, the outputter 140 performs parallel-comparison between a reliability distribution predicted for each sentence in the original document input from the user and a reliability distribution predicted for each sentence in the document enhanced by the reliability enhancer 110 and outputs and provides the comparison results to the user in a graph form. For example, as illustrated in output results of FIG. 4, the outputter 140 may perform parallel-comparison between the reliability distribution predicted for each sentence in the original document and the reliability distribution predicted for each sentence in the enhanced document and may output and provide the comparison results to the user in a graph form.

Here, the outputter 140 may output and provide a reader reliability distribution corresponding to before/after reliability enhancement to the user. Here, since detailed information about the reliability enhancement is provided in a selective and stepwise manner through interaction with the user, the user may perform preliminary monitoring on a change in reliability reaction that may be observed from a group of unspecific others according to micro-deformation of the document input from the user.

Also, the outputter 140 may interact with the user using a drag-and-drop scheme on the output graph. When the user inputs a mode of a desired reliability distribution through the drag-and-drop scheme, the outputter 140 may select a correction candidate having a reliability distribution most similar to the input reliability distribution, may change a document subject to the reliability distribution with the selected correction candidate, and may output and provide again the changed correction candidate, and may change an existing graph interacting with the user using the drag-and-drop scheme with a reliability distribution of the correction candidate and provide the changed reliability distribution.

The controller 150 determines a type of reliability enhancement to be performed among the plurality of enhancement schemes based on the mean and the standard deviation of the reliability distribution.

Here, the controller 150 may determine a type of reliability enhancement to be performed among the plurality of enhancement schemes based on the mean and the standard deviation of the reliability distribution, based on the control information received from the reliability enhancer 110.

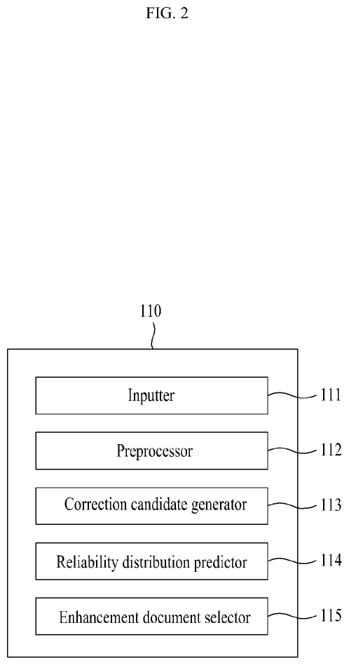

FIG. 2 is a diagram illustrating an example of a configuration of the reliability enhancer of FIG. 1.

Referring to FIG. 2, the reliability enhancer 110 includes an inputter 111, a preprocessor 112, a correction candidate generator 113, a reliability distribution predictor 114, and an enhancement document selector 115.

The inputter 111 receives a document subject to reliability enhancement from a user, selectively receives control information from the user, and transmits the same to the controller 150.

Here, unless the control information is input from the user, the inputter 111 may provide, as control information, information corresponding to all of a plurality of enhancement schemes based on a mean and a standard deviation of a reliability distribution.

Desirably, unless the control information is input from the user, information corresponding to all of the plurality of enhancement schemes based on the mean and the standard deviation of the reliability distribution may be output and provided as the control information.

The preprocessor 112 receives the document input from the user from the inputter 111 and, in response thereto, performs semantic role labeling, dependency parsing, and discourse parsing.

Here, semantic role labeling may be performed through a semantic role extractor such as DeepSemanticRoleLabeling or PathLSTM semantic role labeler, dependency parsing may be performed through a syntax parser such as StanfordCoreNLP, and disclosure parsing may be performed through a disclosure parser such as PDTB-style discourse parser.

The correction candidate generator 113 receives, from the preprocessor 112, (1) the document input from the user and, in relation thereto, (2) semantic role parsing results, (3) dependency parsing results, and (4) disclosure parsing results, and generates a plurality of correction candidate sentence sets for each sentence in the original document.

Here, the correction candidate generator 113 may select L sentences having a smallest semantic difference with the original sentence from among a plurality of correction candidate sentences generable for each sentence and may generate the selected L sentences as the plurality of correction candidate sentence sets.

Desirably, the correction candidate generator 113 may generate a correction candidate sentence through a correction sentence generation model based on supervised learning. Supervised learning of the corresponding model may be performed through the sentence correction candidate corpus 120. Here, a learning model may call original sentences among a plurality of sentence sets from the correction candidate corpus 120 during learning and may perform semantic role parsing, dependency parsing, and disclosure parsing, may use (1) the original sentences, (2) semantic role parsing results, (3) dependency parsing results, and (4) disclosure parsing results as an input standard, and may call and use after-correction sentences corresponding to each of the original sentences and semantic differences between the original sentences and the after-correction sentences as an output standard. Here, semantic role parsing, dependency parsing, and disclosure parsing by the correction candidate generator 113 may be performed in the same manner as in the preprocessor 112.

The reliability distribution predictor 114 receives, from the correction candidate generator 113, (1) sentences in the document input from the user and, in relation thereto, (2) semantic role parsing results, (3) dependency parsing results, (4) disclosure parsing results, and (5) a plurality of correction candidate sentence sets, and predicts a reliability distribution of a reader group for each sentence in a plurality of document sets combinable through the respective sentences in the plurality of sentence sets in the document input from the user and the respective sentences in the plurality of correction candidate sentence sets corresponding thereto.

Here, a process of combining the plurality of document sets through each sentence in the correction candidate sentence sets may be performed by performing a process of randomly selecting a single correction candidate from among a plurality of correction candidates corresponding to sentences of a plurality of sentence sets present in the document input from the user and replacing a corresponding sentence with the selected correction candidate with respect to the entire plurality of sentence sets.

Desirably, the plurality of document sets may be combined in such a manner that M correction candidate documents are generated by iterating the aforementioned random selection and replacement scheme M times. Here, M denotes a natural number that is set as an initial system value and M may be set into consideration of a computation speed of a system and user satisfaction.

Desirably, the reliability distribution predictor 114 predicts a reliability distribution for each sentence using a model trained through supervised learning from the reliability distribution corpus 130. Here, in the case of using each sentence in the plurality of document sets stored in the reliability distribution corpus 130 as a sentence subject to reliability distribution prediction during learning, a learning model may use, as an input standard, semantic role parsing results, dependency parsing results, and disclosure parsing results for a set of 2N+1 sentences that include all of a desired number of, for example, N sentences appearing in front of and N sentences appearing after the sentence subject to the reliability distribution prediction and the corresponding sentence, and may call, from the reliability distribution corpus 130 and use, as an output standard, a reliability distribution for a plurality of sentence sets measured through an actual survey for the sentence subject to the reliability distribution prediction. Here, N denotes a natural number that is set as an initial system value and if a number of sentences less than N are present in front of or after the sentence subject to the reliability distribution prediction in the given document, an absent sentence may be replaced with a null sentence and may be used as an input standard. Here, semantic role parsing, dependency parsing, and disclosure parsing by the reliability distribution predictor 114 may be performed in the same manner as in the preprocessor 113.

The enhancement document selector 115 receives, from the reliability distribution predictor 114, a reliability distribution estimated to have a reader group for each sentence in a plurality of document sets combinable through the respective sentences in a plurality of document sets in the document input from the user and the respective sentences in the plurality of correction candidate sentence sets corresponding thereto, receives, from the controller 150, control information about a plurality of enhancement schemes based on a mean and a standard deviation of the reliability distribution and, and selects a document matching the control information from among preset documents as a reliability-enhanced document.

Here, the preset documents may include (1) an after-correction document with a highest mean of a reliability distribution predicted for each sentence with respect to all of sentences in a corresponding document, (2) an after-correction document with a lowest standard deviation of the reliability distribution predicted for each sentence with respect to all of the sentences in the corresponding document, and (3) an after-correction document with a highest {mean/standard deviation} value predicted for each sentence with respect to all of the sentences in the corresponding document.

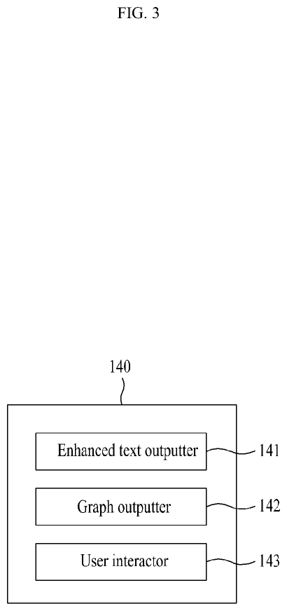

FIG. 3 is a diagram illustrating an example of a configuration of the outputter of FIG. 1.

Referring to FIG. 3, the outputter 140 includes an enhanced text outputter 141, a graph outputter 142, and a user interactor 143.

The enhanced text outputter 141 receives a reliability-enhanced document selected by the enhancement document selector 115 and outputs and provides the same to a user.

The graph outputter 142 receives the reliability-enhanced document selected by the enhancement document selector 115, and also receives, from the reliability predictor 114, (1) reliability distribution prediction results in relation thereto, (2) an original document, and (3) reliability distribution prediction results in relation to the original document, and performs parallel-comparison between a reliability distribution predicted for each sentence in the original document input from the user and a reliability distribution predicted for each sentence in the document enhanced by the reliability enhancer 110 and outputs and provides the same to the user in a graph form.

The user interactor 143 enables an interaction with the user using a drag-and-drop scheme on a reliability distribution graph output to the user by the graph outputter 142. When the user inputs a mode of a desired reliability distribution to the user interactor 143 using the drag-and-drop scheme, the user interactor 143 selects a correction candidate having a reliability distribution most similar to the input reliability distribution, changes a sentence subject to the reliability distribution with the selected correction candidate, and outputs again the changed correction candidate, and changes an existing graph interacting with the user using the drag-and-drop scheme with a reliability distribution of the corresponding correction candidate and outputs again and provides the changed reliability distribution.

Here, the user interactor 143 may allow the user to input the mode of the desired reliability distribution through the drag-and-drop scheme in the reliability distribution graph output from the graph outputter 142.

That is, when the user inputs the mode of the desired reliability distribution to the user interactor 143 using the drag-and-drop scheme, the user interactor 143 may receive, from the reliability distribution predictor 114, each correction candidate among correction candidate sets of a corresponding sentence and a corresponding prediction reliability distribution and selects, from among the correction candidates, a correction candidate having a prediction reliability distribution most similar to the mode of the reliability distribution desired by the user. Here, a distribution similarity may be defined as Kullback-Leibler divergence or Levy-Prokhorov metric.

As described above, the method according to the example embodiments may perform automatic reliability distribution prediction on an available correction candidate set for a given document and may perform reliability enhancement based on a change in a standard deviation and a mean appearing in a reliability distribution for a correction candidate set and an original document.

Also, the method according to the example embodiments enables a document correction for a reliability concept including a large individual difference since a necessary condition, the introduction of a distribution concept, is met. That is, the method according to the example embodiments may (1) perform reliability enhancement of a scheme that aims at a high mean of a reliability distribution and correct a document such that more people may trust the document subject to the reliability enhancement, (2) perform reliability enhancement of a scheme that aims at a low standard deviation of the reliability distribution and correct the document such that there is no room for controversy about an issue whether to trust the document subject to the reliability enhancement, and (3) perform reliability enhancement of a scheme that aims at high {mean/standard deviation} of the reliability distribution and correct the document subject to reliability enhancement in a combined manner of the two schemes.

Also, the method according to the example embodiments enables a user to input a mode of a desired reliability distribution through a drag-and-drop scheme for each sentence in a document to be corrected and may provide the user with a sentence correction candidate showing a most similar reliability distribution mode to the mode of the corresponding reliability distribution. Therefore, the example embodiments enable document correction for reliability enhancement, which is difficult to apply to an automated correction system since it is greatly affected by individual subjectivity through introduction of a distribution concept. Through this, detailed information about how the document needs to be transformed to earn more trust from a group of unspecific others may be provided in various forms.

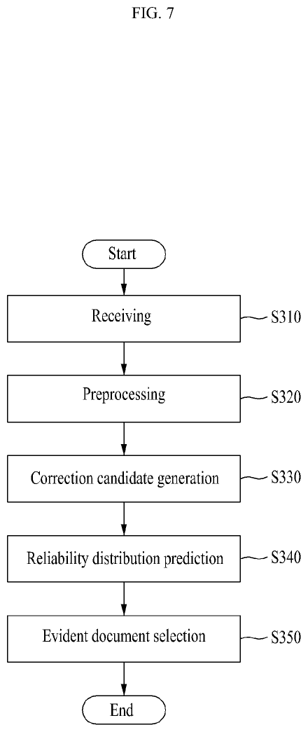

FIG. 7 is a flowchart illustrating an example of the reliability enhancer of FIG. 1.

Referring to FIG. 7, a method by the reliability enhancer 110 includes receiving operation S310, preprocessing operation S320, correction candidate generation operation S330, reliability distribution prediction operation S340, and evident document selection operation S350.

Receiving operation S310 refers to an operation of receiving a document subject to reliability enhancement from a user and selectively receiving control information about a plurality of enhancement schemes based on a mean and a standard deviation of a reliability distribution from the user. Preprocessing operation S320 refers to an operation of performing preprocessing of each sentence in the document received from the user. Correction candidate generation operation S330 refers to an operation of generating a plurality of correction candidate sentence sets for each sentence in an original document. Reliability distribution prediction operation S340 refers to an operation of predicting a reliability distribution estimated to have a reader group for each sentence in a plurality of document sets combinable through the respective sentences in a plurality of document sets in the document input from the user and the respective sentences in a plurality of correction candidate sentence sets corresponding thereto. Evident document selection operation S350 refers to an operation of selecting a reliability-enhanced document based on control information by parsing the reliability distribution estimated to have a reader group for each sentence in the plurality of document sets combinable through the respective sentences in the plurality of document sets in the document input from the user and the respective sentences in the plurality of correction candidate sentence sets corresponding thereto.

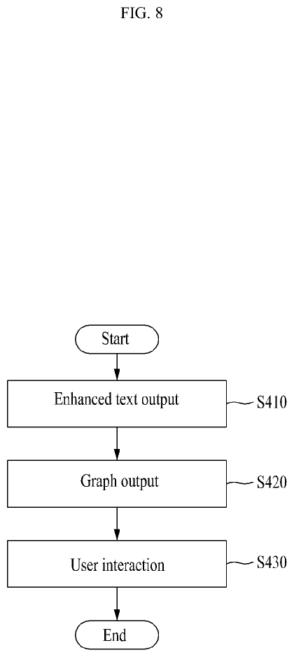

FIG. 8 is a flowchart illustrating an example of the outputter of FIG. 1.

Referring to FIG. 8, a method by the outputter 140 includes enhanced text output operation S410, graph output operation S420, and user interaction operation S430.

Enhanced text output operation S410 refers to an operation of outputting and providing a reliability-enhanced document to a user. Graph output operation S420 refers to an operation of performing parallel-comparison between a reliability distribution predicted for each sentence in the original document input from the user and a reliability distribution predicted for each sentence in the enhanced document and outputting and providing the same to the user in a graph form. User interaction operation S430 refers to an operation of enabling interaction with the user using a drag-and-drop scheme on a reliability distribution graph output to the user and, in response to the user inputting a mode of a desired reliability distribution through the drag-and-drop scheme, selecting a correction candidate having a reliability distribution most similar to the input reliability distribution, changing a sentence subject to the reliability distribution with the selected correction candidate and outputting again the changed correction candidate, and changing an existing graph interacting with the user using the drag-and-drop scheme with a reliability distribution of the corresponding correction candidate and providing the changed reliability distribution.

Although related description is omitted in the methods of FIGS. 7 and 8, it is apparent to those skilled in the art that the respective operations of FIGS. 7 and 8 may include all the contents described with reference to FIGS. 1 to 6.

The systems or the apparatuses described herein may be implemented using hardware components, software components, and/or a combination thereof. For example, the systems, the apparatuses, and the components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be permanently or temporally embodied in any type of machine, component, physical equipment, virtual equipment, computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in non-transitory computer-readable media. The media may also include, alone or in combination with the program instructions, data files, data structures, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to operate as one or more software modules to perform the operation of the example embodiments or vice versa.

While the example embodiments are described with reference to specific example embodiments and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. A document reliability enhancement method comprising:
when a document is input from a user, generating a correction candidate set for each sentence of the input document;
predicting a reliability distribution for each of the input document and the generated correction candidate set; and
performing reliability enhancement for the input document through a plurality of enhancement schemes based on a mean and a standard deviation of the predicted reliability distribution.

2. The document reliability enhancement method of claim 1, further comprising:
providing the user with a reliability-enhanced document with enhanced reliability for the input document and information about a change in the reliability distribution occurring before and after the reliability enhancement.

3. The document reliability enhancement method of claim 2, wherein the providing the user comprises further providing the user with document correction results most similar to a mode of a reliability distribution desired by the user through interaction with the user.

4. The document reliability enhancement method of claim 1, wherein the plurality of enhancement schemes comprises at least one item among a first item corresponding to reliability enhancement of a scheme that aims at a preset reference mean or more of the reliability distribution, a second item corresponding to reliability enhancement of a scheme that aims at a standard deviation less than a preset reference standard deviation of the reliability distribution, and a third item corresponding to reliability enhancement of a scheme that aims at {mean/standard deviation} greater than or equal to a preset standard {mean/standard deviation} of the reliability distribution.

5. The document reliability enhancement method of claim 1, wherein the generating comprises:
receiving control information about the plurality of enhancement schemes from the user;
performing preprocessing of each sentence of the input document; and
generating a plurality of correction candidate sentence sets for each sentence of the input document,
the predicting comprises predicting a reliability distribution for each sentence of a plurality of document sets combinable through the respective sentences of the input document and the respective sentences in the correction candidate sentence sets, and
the performing comprises performing the reliability enhancement for the input document by selecting a reliability-enhanced document based on the predicted reliability distribution for each sentence of the plurality of document sets and the control information.

6. A document reliability enhancement system comprising:
a generator configured to, when a document is input from a user, generate a correction candidate set for each sentence of the input document;
a predictor configured to predict a reliability distribution for each of the input document and the generated correction candidate set; and
an enhancer configured to perform reliability enhancement for the input document through a plurality of enhancement schemes based on a mean and a standard deviation of the predicted reliability distribution.

7. The document reliability enhancement system of claim 6, further comprising:
an outputter configured to provide the user with a reliability-enhanced document with enhanced reliability for the input document and information about a change in the reliability distribution occurring before and after the reliability enhancement.

8. The document reliability enhancement system of claim 7, wherein the outputter is configured to further provide the user with document correction results most similar to a mode of a reliability distribution desired by the user through interaction with the user.

9. The document reliability enhancement system of claim 6, wherein the plurality of enhancement schemes comprises at least one item among a first item corresponding to reliability enhancement that aims at a preset reference mean or more of the reliability distribution, a second item corresponding to reliability enhancement of a scheme that aims at a standard deviation less than a preset reference standard deviation of the reliability distribution, and a third item corresponding to reliability enhancement of a scheme that aims at {mean/standard deviation} greater than or equal to a preset standard {mean/standard deviation} of the reliability distribution.

10. The document reliability enhancement system of claim 6, wherein the generator is configured to receive control information about the plurality of enhancement schemes from the user, to perform preprocessing of each sentence of the input document, and to generate a plurality of correction candidate sentence sets for each sentence of the input document,
the predictor is configured to predict a reliability distribution for each sentence of a plurality of document sets combinable through the respective sentences of the input document and the respective sentences in the correction candidate sentence sets, and
the enhancer is configured to perform the reliability enhancement for the input document by selecting a reliability-enhanced document based on the predicted reliability distribution for each sentence of the plurality of document sets and the control information.
